(19) United States
(12) Patent Application Publication
(10) Pub. No.: US 2010/0170975 A1
(43) Pub. Date: Jul. 8, 2010

(54) INDUSTRIAL APPARATUS

(75) Inventor: William Graham Bell, Stafford (GB)

Correspondence Address: ADAMS INTELLECTUAL PROPERTY LAW, Suite 2350 Charlotte Plaza, 201 South College Street, CHARLOTTE, NC, 28244, US

(73) Assignee: SOUTHWESTERN CORPORATION LIMITED, Rugeley (UK)

(21) Appl. No.: 12/602,383

(22) PCT Filed: May 28, 2008
(86) PCT No.: PCT/GB2008/050382

§ 371 Date: Feb. 26, 2010

(30) Foreign Application Priority Data
May 31, 2007 (GB) 0710401.1

(51) Int. Cl. B02C 15/12; B02C 23/00

(52) U.S. Cl. 241/285.1; 241/117; 241/285.2

(57) ABSTRACT

A grinding mill requiring one or more new grinding balls is adapted so that they can be passed into the mill through spider-guide apertures. The spider-guide apertures provide anchors for spider-guide mountings, by means of which a spider used to grip an upper ring is restrained against rotation. There may be provided two mounting frames between the spider-guide mounting, and the mill. Frame is secured to the mill and has a large opening, able to pass a grinding ball. Frame is secured to frame and has a smaller opening, and provides a mounting location for the spider-guide mounting. The arrangement means that mill disassembly and lifting then lowering grinding balls is no longer needed.

This invention relates to industrial apparatus, namely a mill, in which pieces of a material are pulverised into a particulate form. The invention relates particularly, but not exclusively, to a mill in which coal is pulverised into a particulate form which is conveyed to combustion apparatus e.g. of a power station.

In particular the invention concerns a mill having a lower grinding ring formed with an annular depression. Grinding elements sit in the annular depression and are sandwiched between the lower grinding ring and a top ring.

Typically the required relative movement between the grinding elements and the lower grinding ring is achieved by driving the grinding ring, while the top ring is held against rotation by a gripping arrangement called, conventionally and herein, a “spider” ring. The grinding elements are not driven, but are free to precess. The spider ring has parts which grip the top ring and parts which anchor the spider ring on the side wall of the mill. The spider ring rests on top of the top ring positioned on a central spigot and located by two drive/location dogs. It is positioned in the mill using spider guides.

The grinding elements are typically steel balls of diameter 60-80 cm, when new. They are hollow, typically having a wall thickness of 10-15 cm, when new. When new, the grinding elements take up most of the available space in the annular depression in the grinding ring. That is to say the grinding ring accommodates the maximum number of grinding elements possible; there is no room for an extra grinding element.

Naturally there is a slow but inexorable process of wear, at the abutting surfaces of the grinding ring, top ring and grinding elements. Over a long period of time the grinding elements wear down, and their diameter decreases. Contact is maintained between the grinding ring, top ring and grinding elements by virtue of the weight of the grinding elements and of the top ring, spider ring and pressure rams. There comes a time when there are substantial spaces between grinding elements, such that a further grinding element could be added. It is desirable to add a further grinding element; not to do so would mean accepting diminishing grinding performance and increasing the wear between grinding elements, and the likelihood for catastrophic failure, as they continually “cannon” against each other.

There is, therefore, a so-called “Add-Ball” procedure whereby a grinding element is added, of similar size to the in-situ grinding elements at that stage of their working life (smaller than the initial diameter, and larger then the smallest diameter that will be reached).

The conventional approach to an Add-Ball procedure is to shut down the mill and partially disassemble it from the top, removing parts, to the point where the top ring is lifted off, exposing the grinding elements. The additional grinding element can then be introduced, and the mill re-assembled. This is a time consuming and expensive operation.

On the other hand, if an opening could be made in the side wall of the mill, at approximately the height of the operational grinding elements, and the top ring raised sufficiently (i.e. lifted or tilted) an additional grinding element could be introduced. However this idea is not favoured. There is typically little available space in the wall to make such an opening. As well as room for the opening, there must be room adjacent to the opening, for the heavy grinding element to be manoeuvred, and introduced into its location. The operation also requires the raising of the top ring, and this requires machinery, and room for that machinery.

However the side wall of the mill does have some openings. The spider is anchored at sites (typically four) in the wall of the mill, at what we call “spider-guide mountings” herein. Each spider-guide mounting covers a respective opening which we call herein a “spider-guide aperture” in the side wall of the mill. However spider-guide apertures, if exposed, would be too small to pass an additional grinding element.

In accordance with a first aspect of the present invention there is provided a method of adapting a mill to permit the introduction of an additional grinding element, the mill being of the type having a grinding arrangement comprising grinding elements retained between a lower rotatable grinding ring and a top ring, the top ring being held against rotation by a spider having legs anchored in spider-guide mountings secured at or around spider-guide apertures in a side wall of the mill, which spider-guide apertures are too small to pass a grinding element, the method comprising the steps of:
removing a spider-guide mounting to expose a spider-guide aperture;
enlarging the spider-guide aperture to a size which can pass an additional grinding element; and
removably fitting the spider-guide mounting at or around the enlarged aperture.

The spider-guide mounting is likely to be too small to be mounted at or around the enlarged aperture without assistance or adaptation (although it is not excluded that it could be large enough). Its span or “footprint” could be enlarged by fitting it to an adapter plate or flange of greater span or “footprint” (itself apertured, of course). Such an adapter plate or flange may be secured to the side wall of the mill externally, for example, by welding or by bolts. The adapter plate or flange could be one-piece or could be formed of a series of strips, used to give the same effect, i.e. increase the “footprint” of the spider-guide mounting. The spider-guide mounting may then be secured around the enlarged aperture, through the agency of the adapter plate or flange.

There may additionally be provided a new door mounting frame. This may be a part directly secured about the enlarged aperture. The new door mounting frame suitably has a large aperture, large enough to pass an additional grinding element, and intended to be permanently secured to the mill. Said adapter plate or flange is adapted to be secured to the new door mounting frame, and the spider-guide mounting is preferably adapted to be secured to the adapter plate.

The mill is preferably of the type having a rotating port ring arrangement as described in EP 0507983. In such an arrangement a rotating port ring assembly is provided, between the periphery or circumference of the grinding ring and the wall of the mill. There is provided an annular passage or “throat”, just outboard of the grinding ring. Air flows upwardly through the throat. The throat has a plurality of spaced-apart vane members. The vane members rotate with the grinding ring, to impart a desired vector to the generally upwards air flow. Extending between the side wall and the throat is a skirt on the downstream side, obliquely inclined relative to the general direction of air flow. From the periphery of the skirt an inner wall may project, generally axially of the mill, and in the upstream direction.

Suitably the enlarged aperture in the side wall, through which an additional grinding element may pass, is at the level of the port ring arrangement and the port ring arrangement may be disturbed by the enlargement. Suitably there is provided a part—for example a said plate or flange or mounting plate or door mounting frame—which includes a part or parts which makes good any disturbance or interruption of the port ring arrangement. For example there may project from one of said parts an inclined part which constitutes a part-circumference of the said skirt, corresponding to a part-circumference removed on enlarging the aperture. From that inclined part there may downwardly depend a part which constitutes a part-circumference of said inner wall, closely adjacent to the outer periphery or the port ring assembly.

In accordance with a second aspect of the present invention there is provided a mill having a mill body enclosing a grinding arrangement comprising grinding elements sandwiched between a lower rotatable grinding ring and a top ring, the top ring being held against rotation by a spider having legs anchored in spider-guide mountings mounted around apertures in the body of the mill, at least one such aperture being sufficiently large to pass a grinding element, and the spider-guide mounting being removable to permit this to happen.

In accordance with a third aspect of the present invention there is provided a method of adding an additional grinding element to a mill of the second aspect, without axial disassembly of the mill to expose its grinding elements, the method comprising the introduction of the additional grinding element through a said sufficiently large aperture.

The invention will now be further described, by way of example, with reference to the accompanying drawings, in which:

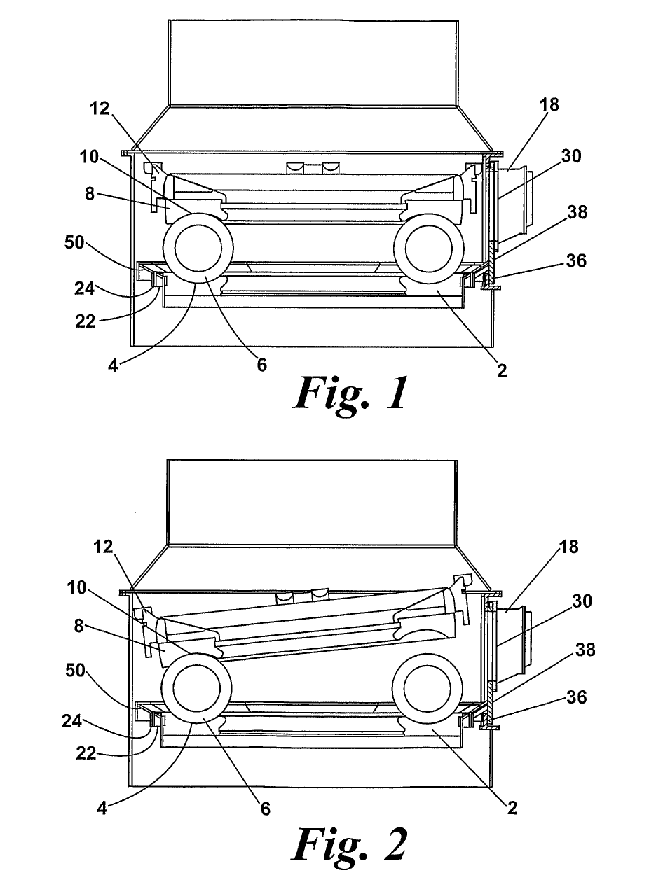

FIG. 1 is a schematic side sectional view of the grinding part of a pulverizer mill, in operational condition;

FIG. 2 a schematic side sectional view of the pulverizer mill shown in FIG. 1, configured for the addition of a grinding element; and

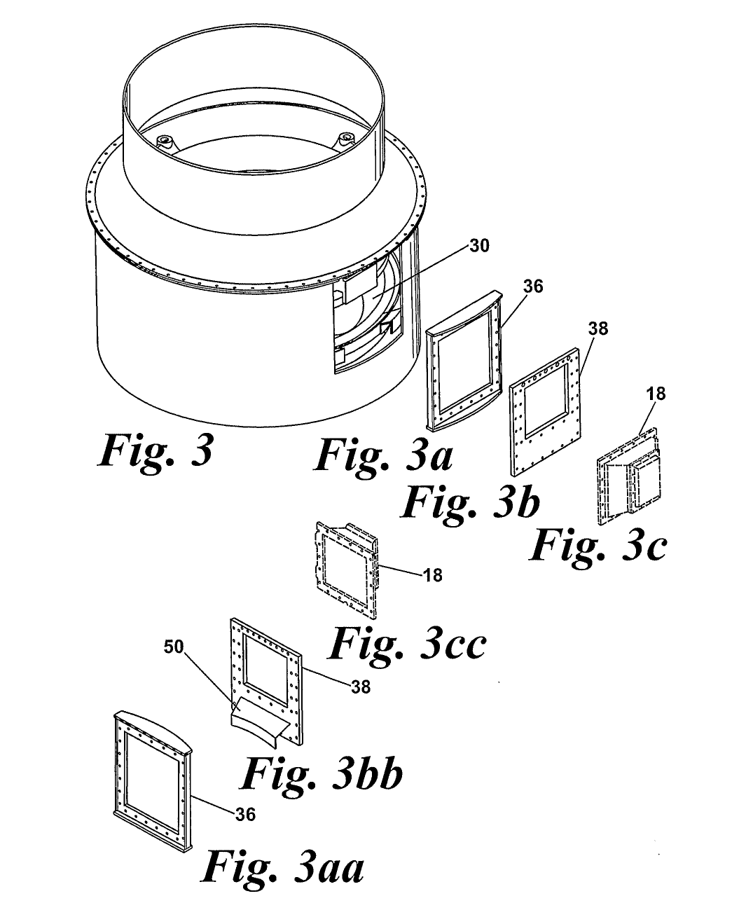

FIG. 3 is an external perspective view of the same mill, showing the exposed opening to allow the grinding element to be added, through the wall of the mill;

FIGS. 3a-3c are figures representing a perspective exploded view of the removed external parts of the same mill obliquely from one side; and

FIGS. 3aa-3cc are figures representing a perspective exploded view of the removed parts, obliquely from a different angle.

The pulverizer mill has a driven, lower steel grinding ring 2, having a circumferential groove 4, in which a plurality of spherical grinding elements 6 are located. The groove contains the maximum number of grinding elements that it can. Above the grinding elements is located a steel top ring 8, which has a downwardly-facing circumferential groove 10. Therefore the arrangement is like a ball race, with the balls, or grinding elements, are rotatable within the oppositely-directed grooves 4, 10.

The top ring 8 must be held against rotation and this is achieved by means of a spider arrangement or ring 12. The spider arrangement 12 has four legs, each anchored in a respective spider-guide door assembly 18, which is a frusto-pyramidal tray-like body.

The grinding elements are steel balls of diameter 60-80 cm, when new. They are hollow, typically having a wall thickness of 10-15 cm, when new.

This type of pulverizer mill is used in a highly demanding environment, to crush coal into fines (powder) to be combusted. The coal fines are carried upwardly by an air current, towards the combustion apparatus. Coal itself can cause considerable wear but it will be appreciated that mined coal frequently contains inclusions of stone or rock. Over time, therefore, the grinding elements will wear down.

Around the grinding ring 2 is a narrow throat 22 and in the throat 22 there is provided a port ring assembly 24. This contains a port ring, which rotates with the grinding ring, to impart a desired movement to the upwardly-directed air, which carries the coal fines to the combustion apparatus.

As shown in FIG. 1 the grinding ring 2 and the top ring 8 are horizontal.

When a grinding element is to be added, access to the interior of the pulverizer mill is gained through a side aperture 30 associated with the spider-guide mounting (see FIG. 3). The top ring is tilted upwardly into the position shown in FIG. 2, and an additional grinding element, of the same diameter as the existing grinding elements, is introduced onto the circumferential groove of the grinding ring. The top ring is then lowered onto the grinding elements.

In a conventional pulverizer mill the spider-guide mounting 18 is associated with an aperture of similar size. However such an aperture would not be large enough to pass a further grinding element. Therefore the wall of the pulverizer mill has been cut with a larger aperture 30, large enough to pass a new grinding element. Because the spider-guide mounting 18 is smaller than the aperture 30, an adapter plate 38 is provided. As will be seen in FIG. 3 there is an aperture shield plate 36 having a larger aperture (large enough to pass the new grinding element) and, to be fitted externally of it, the adapter plate 38 having a smaller aperture, sufficient to receive the spider-guide, and around and to which the spider-guide mounting 18 can be fitted.

It will be seen in FIG. 3bb that the adapter plate 38 has, inclined downwardly from its lower region, a body liner portion 50. This wall element 50 makes up part of the port ring assembly; the portion of the port ring assembly which had to be breached in order to form an aperture of sufficient size to pass the grinding element.

As constructed the mill shown in FIGS. 1-3 has four relatively small apertures 30 in its side wall. Those apertures corresponded approximately in size to the aperture in the adapter plate 38. Apertures of this size would be perfectly suitable to allow the legs of the spider arrangement to be anchored in the respective spider-quide mountings 18, but not large enough to permit a grinding element to be introduced. Accordingly at least one such aperture 30 is enlarged. The spider-guide mountings 18 cannot be re-engaged with the side wall without an adaptation being made. The adaptation is the provision of the two intermediate parts 36, 38.

The net result is that spider-guide mounting 18 can be reintroduced into the same location, and can anchor a spider-guide, as before. However, when a grinding element is to be introduced, parts 18 and 38 can be detached from the side wall (and the spider-guide disengaged, of course). The grinding element can then be introduced, though the enlarged aperture 30, defined within the new door mounting frame 36.

It is envisaged that the present invention will have most significant utility in relation to the adaptation of existing mills. However the present invention also embraces the idea that, in future, new mills may be manufactured with at least one dual purpose aperture, the first purpose being to anchor a spider-guide, and the second purpose being to permit a grinding element to be introduced, when needed.

1. A method of adapting a mill to permit the introduction of an additional grinding element, the mill being of the type having a grinding arrangement comprising grinding elements retained between a lower rotatable grinding ring and a top ring, the top ring being held against rotation by a spider having legs anchored in spider-guide mountings secured at or around spider-guide apertures in a side wall of the mill, which spider-guide apertures are too small to pass a grinding element, the method comprising the steps of:
removing a spider-guide mounting to expose a spider-guide aperture;
enlarging the spider-guide aperture to a size which can pass an additional grinding element; and
removably fitting the spider-guide mounting at or around the enlarged aperture.

2. A method as claimed in claim 1, comprising the steps of fitting to the enlarged spider-guide aperture an aperture adapter plate of greater span than the enlarged spider-guide aperture, and securing the spider-guide mounting at or around the enlarged aperture, through the agency of the adapter plate.

3. A method as claimed in claim 2, comprising the steps of permanently securing a new door mounting frame to the mill, about the enlarged aperture, the new door mounting frame having a large aperture, large enough to pass an additional grinding element; securing the adapter plate to the new door mounting frame; and securing the spider-guide mounting to the adapter plate.

4. A method as claimed in claim 2, wherein the mill has a rotating port ring assembly in the annular passage between the periphery of the grinding ring and the wall of the mill, to impart a desired vector to the generally upwards air flow, and a skirt extending between the side wall and the annular passage on the downstream side of the port ring assembly, obliquely inclined relative to the general direction of air flow, wherein the enlarged aperture is at the level of the port ring arrangement, wherein there projects from the adapter plate or the new door mounting frame (when provided) an inclined part which constitutes a part-circumference of the said skirt, corresponding to a part-circumference removed on enlarging the aperture.

5. A mill having a mill body enclosing a grinding arrangement comprising grinding elements sandwiched between a lower rotatable grinding ring and a top ring, the top ring being held against rotation by a spider having legs anchored in spider-guide mountings mounted around apertures in the body of the mill, at least one such aperture being sufficiently large to pass a grinding element, and the spider-guide mounting being removable to permit this to happen.

6. (canceled)

7. A method of adding an additional grinding element to a grinding mill without axial disassembly of the mill to expose its grinding elements, the method comprising the introduction of the additional grinding element through a sufficiently large aperture.

8. A method as claimed in claim 7, the mill having a mill body enclosing a grinding arrangement comprising grinding elements sandwiched between a lower rotatable grinding ring and a top ring, the top ring being held against rotation by a spider having legs anchored in spider-guide mountings mounted around apertures in the body of the mill, at least one such aperture being sufficiently large to pass a grinding element, and the spider-guide mounting being removable to permit this to happen.

9. (canceled)

10. (canceled)

11. A method as claimed in claim 7, wherein the mill has a mill body enclosing a grinding arrangement comprising grinding elements sandwiched between a lower rotatable grinding ring and a top ring, the top ring being held against rotation by a spider having legs anchored in spider-guide mountings mounted around apertures in the body of the mill, at least one such aperture being sufficiently large to pass a grinding element, and the spider-guide mounting being removable to permit this to happen, and wherein the additional grinding element is further added by the method comprising the steps of:
removing a spider-guide mounting to expose a spider-guide aperture;
enlarging the spider-guide aperture to a size which can pass an additional grinding element; and
removably fitting the spider-guide mounting at or around the enlarged aperture.

12. A method as claimed in claim 11, further comprising the steps of fitting to the enlarged spider-guide aperture an aperture adapter plate of greater span than the enlarged spider-guide aperture, and securing the spider-guide mounting at or around the enlarged aperture, through the agency of the adapter plate.

13. A method as claimed in claim 12, further comprising the steps of permanently securing a new door mounting frame to the mill, about the enlarged aperture, the new door mounting frame having a large aperture, large enough to pass an additional grinding element; securing the adapter plate to the new door mounting frame; and securing the spider-guide mounting to the adapter plate.

14. A method as claimed in claim 13, wherein the mill has a rotating port ring assembly in the annular passage between the periphery of the grinding ring and the wall of the mill, to impart a desired vector to the generally upwards air flow, and a skirt extending between the side wall and the annular passage on the downstream side of the port ring assembly, obliquely inclined relative to the general direction of air flow, wherein the enlarged aperture is at the level of the port ring arrangement, wherein there projects from the adapter plate or the new door mounting frame (when provided) an inclined part which constitutes a part-circumference of the said skirt, corresponding to a part-circumference removed on enlarging the aperture.
